(19) United States
(12) Patent Application Publication
(10) Pub. No.: US 2026/0175929 A1
(43) Pub. Date: Jun. 25, 2026

(54) VEHICLE SPOILER ASSEMBLY

(71) Applicant: NISSAN NORTH AMERICA, INC., Franklin, TN (US)

(72) Inventor: Miguel Angel BANTHI, Toluca (MX)

(21) Appl. No.: 19/000,171

(22) Filed: Dec. 23, 2024

(51) Int. Cl. B62D 35/00

(52) U.S. Cl. CPC B62D 35/007; B62D 35/008

(57) ABSTRACT

A vehicle spoiler assembly includes a main spoiler and a side spoiler. The main spoiler is configured to be secured to a vehicle. A tab extends outwardly from the main spoiler. The side spoiler is configured to be connected to the main spoiler and to the vehicle. A boss protrudes outwardly from the side spoiler. An opening extends through the boss. The opening is configured to receive the tab when the side spoiler is connected to the main spoiler.

### BACKGROUND

### Technical Field

The present disclosure generally relates to a spoiler assembly for a vehicle. More specifically, the present disclosure relates to a vehicle spoiler assembly in which a tab of a main spoiler is configured to be received by a side spoiler to facilitate aligning the side spoiler with the main spoiler during assembly.

### Background Information

A spoiler assembly for a vehicle includes a main spoiler and a pair of side spoilers. The side spoilers are connected to opposing ends of the main spoiler. During assembly, the side spoiler is manually held such that a fastener can be inserted to secure the side spoiler to the main spoiler. Holding the side spoiler with one hand while inserting the fastener with the other hand is unwieldy, and can result in the side spoiler being dropped, thereby damaging the side spoiler. Additionally, while torquing the fastener, the side spoiler can rotate relative to the main spoiler, thereby resulting in misalignment, or other fit and finish issues, between the side spoiler and the main spoiler, which can provide an undesired appearance.

### SUMMARY

A need exists for an improved vehicle spoiler assembly.

In view of the state of the known technology, one aspect of the present disclosure is to provide a spoiler assembly for a vehicle. The vehicle spoiler assembly includes a main spoiler and a side spoiler. The main spoiler is configured to be secured to a vehicle. A tab extends outwardly from the main spoiler. The side spoiler is configured to be connected to the main spoiler and to the vehicle. A boss protrudes outwardly from the side spoiler. An opening extends through the boss. The opening is configured to receive the tab when the side spoiler is connected to the main spoiler.

Another aspect of the present disclosure is to provide a vehicle spoiler assembly including a main spoiler and a side spoiler. The main spoiler is configured to be secured to a vehicle. A tab extends outwardly from an edge of the main spoiler. The side spoiler is configured to be connected to the main spoiler and to the vehicle. A boss protrudes outwardly from an inner surface of the side spoiler. An opening extends through the boss. A hook is disposed at a first end of the tab. The tab is configured to be received by the opening when the side spoiler is connected to the main spoiler. The hook is configured to engage the boss to prevent accidental removal of the side spoiler from the main spoiler when the side spoiler is connected to the main spoiler.

### BRIEF DESCRIPTION OF THE DRAWINGS

Referring now to the attached drawings which form a part of this original disclosure:

FIG. 1 is a rear elevational view of a spoiler assembly in accordance with an exemplary embodiment connected to a vehicle;

FIG. 2 is an exploded assembly view of the spoiler assembly of FIG. 1;

FIG. 3 is a bottom exploded assembly view of the spoiler assembly of FIG. 1;

FIG. 4 is a perspective view of a side spoiler connected to a main spoiler of the spoiler assembly of FIG. 1;

FIG. 5 is a an elevational view in cross section of the spoiler assembly;

FIG. 6 is a perspective view of the side spoiler prior to being connected to the main spoiler;

FIG. 7 is a perspective view of a tab of the main spoiler of FIG. 2;

FIG. 8 is a perspective view of the spoiler assembly connected to the vehicle; and

FIG. 9 is an elevational view in cross section of the spoiler assembly of FIG. 8.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

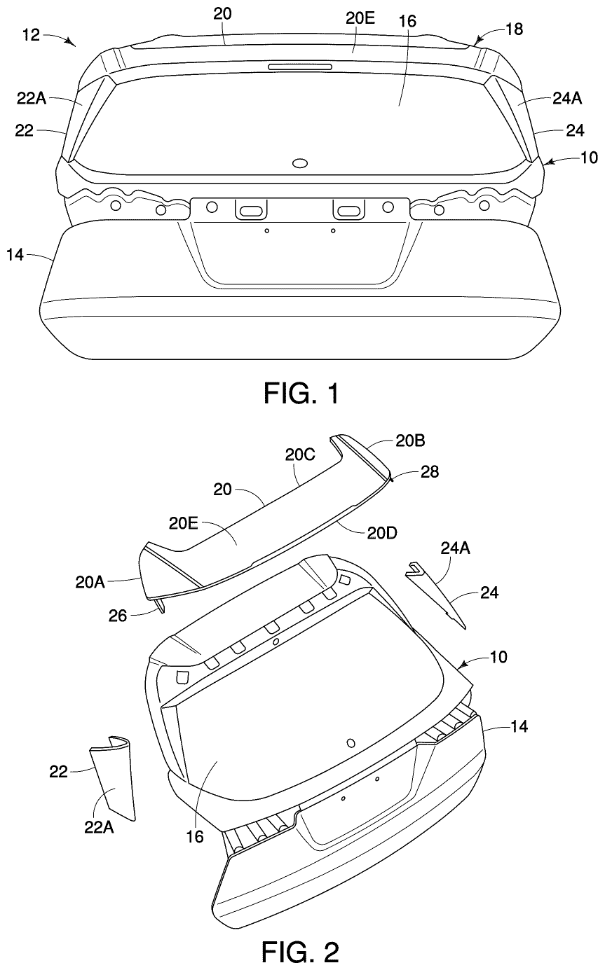

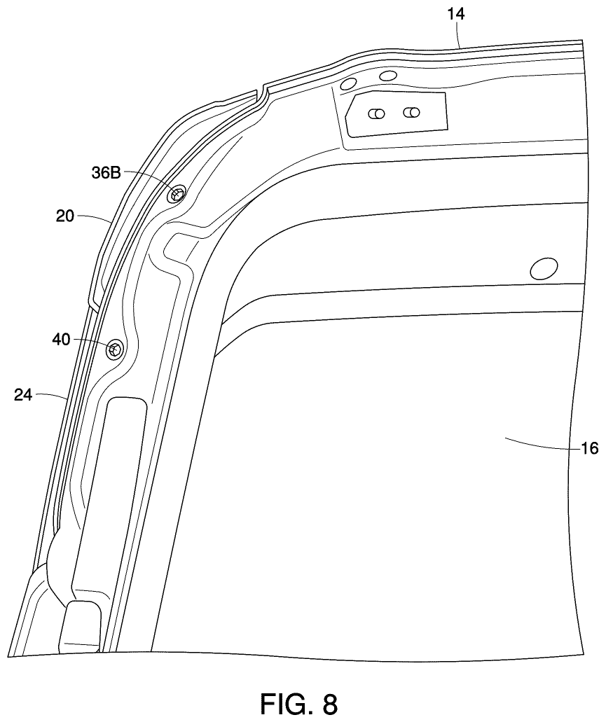

A rear, or vehicle, body structure 10 of a vehicle 12 includes a back door 14, a rear window glass (e.g., window panel) 16, and a spoiler assembly 18, as shown in FIGS. 1, 2, 8 and 9. The spoiler assembly 18 includes a main spoiler 20 and a pair of side spoilers 22 and 24. The back door 14 is typically formed of metal or any other suitable material that is typically used in vehicles. The back door 14 is pivotally mounted to a roof panel of the vehicle 12. The back door 14 defines an opening providing access to a rear cargo area of the vehicle 12. The rear window glass 16 disposed on the back door 14 covers the opening. Specifically, the rear window glass 16 is fixedly coupled the back door 14 in a conventional manner well known in the art.

The main spoiler 20 and the first and second side spoilers 22 and 24 are preferably made of plastic or any other suitable material that provides rigidity, such as fiberglass, silicon or carbon fiber. The main spoiler 20 is integrally formed as a one-piece, unitary member. Each of the side spoilers 22 and 24 is also integrally formed as a one-piece, unitary member.

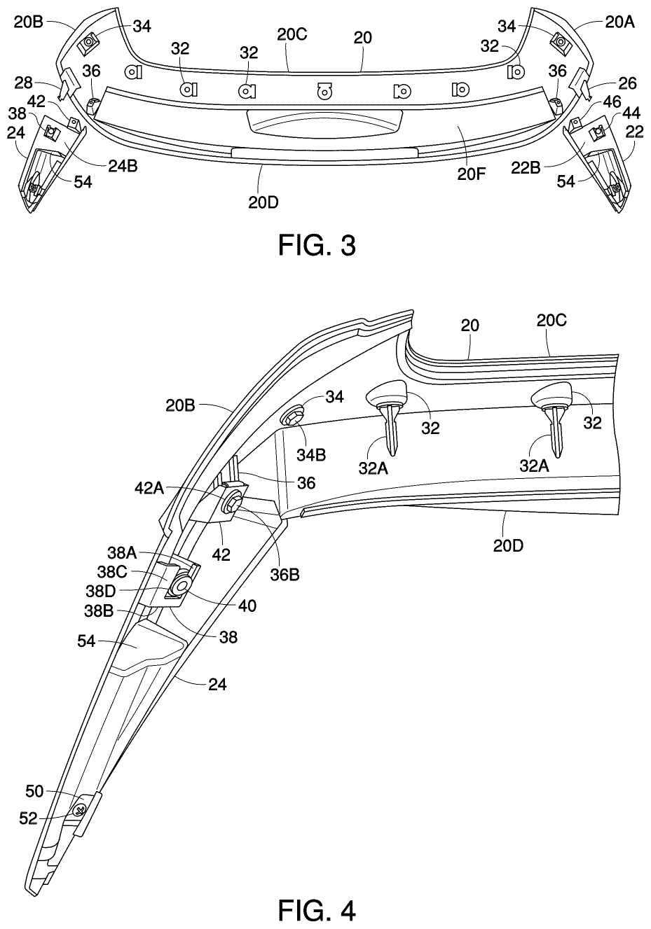

Each of the side spoilers 22 and 24 is connected to the main spoiler 20 to form the spoiler assembly 18. As shown in FIG. 3, each of the side spoilers 22 and 24 is connected to the main spoiler 20 at opposite lateral end portions of the main spoiler 20. The spoiler assembly 18 is connected to the exterior surface of the back door 14 such that the main spoiler 20 is connected across a top edge of the back door 14, as shown in FIGS. 1 and 2. In other words, the main spoiler 20 is configured to be connected to the vehicle 12. Each of the side spoilers 22 and 24 is connected to the main spoiler 20 and to the exterior surface of the back door 14 such that the side spoilers 22 and 24 extend downwardly from the main spoiler 20 along both side edge portions (e.g., peripheral edge portions) of the rear window glass 16, respectively. In other words, each of the side spoilers 22 and 24 is configured to be connected to the main spoiler 20 and to the vehicle 12.

The main spoiler 20 is defined by an upper edge 20C extending between upper ends of the first and second lateral edges 20A and 20B, and a lower edge 20D extending between lower ends of the first and second lateral edges 20A and 20B, as shown in FIGS. 2 and 3. The main spoiler 20 has an outer surface 20E facing away from the vehicle 12 when connected to the vehicle 12, and an inner surface 20F facing the vehicle 12 when connected to the vehicle 12.

A first tab 26 extends outwardly proximate the first lateral edge 20A of the main spoiler 20, as shown in FIGS. 2-4. A second tab 28 extends outwardly proximate the second lateral edge 20B of the main spoiler 20, as shown in FIGS. 2-4. The first tab 26 extends outwardly from the lower edge 20D of the main spoiler 18 proximate the first lateral edge 20A. The second tab 28 extends outwardly from the lower edge 20D of the main spoiler 20 proximate the second lateral edge 20B.

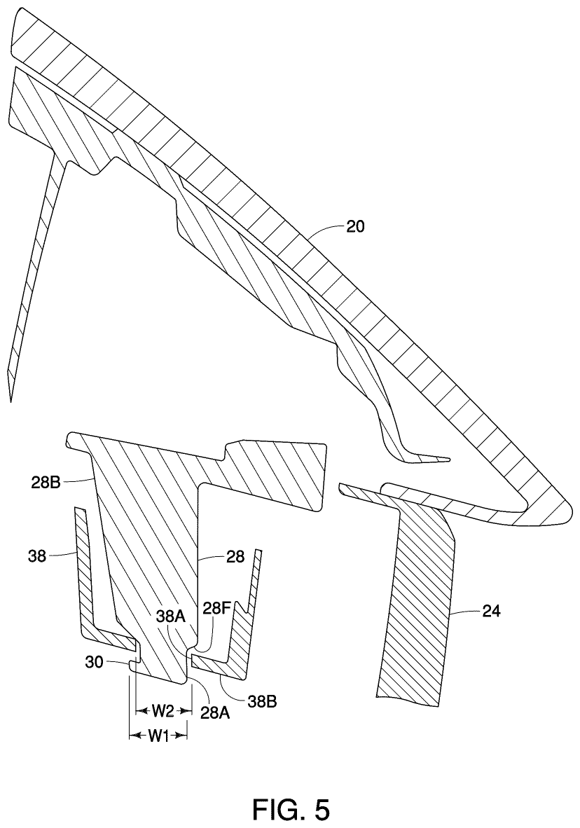

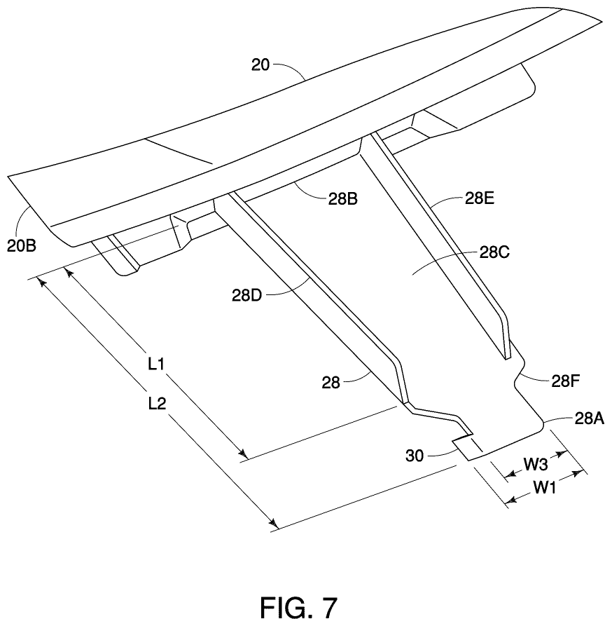

A hook 30 is disposed at a first end 28A of the second tab 28, as shown in FIGS. 5-7. The second tab 28 includes a substantially planar surface 28C extending from the first end 28A to the second end 28B of the second tab 28. A first side wall 28D and a second side wall 28E extend from upwardly from opposite lateral edges of the substantially planar surface 28C. The first and second side walls 28D and 28E are preferably substantially perpendicular to the substantially planar surface 28C. The first and second planar walls 28D and 28E extend from the second end 28B of the second tab 28 toward the first end 28A of the second tab 28, as shown in FIG. 7. A length of each of the first and second side walls 28D and 28E is preferably substantially equal. A first length L1 of each of the first and second side walls 28D and 28E is less than a second length L2 of the second tab 28. A tapering portion 28F is formed between an end of the first and second side walls 28D and 28E and the hook 30. A third width W3 of the tapering portion 28F is less than a first width W1 of the hook 30. The tab 30 is preferably integrally formed with the main spoiler 20 as a one-piece member.

The first tab 26 of the first side spoiler 22 is preferably a mirror image of the second tab 28 of the second side spoiler 24, such that a description thereof is omitted for brevity.

A plurality of first attachment portions 32 are disposed on the inner surface 20F of the main spoiler 20 to connect the main spoiler 20 to the door 14 of the vehicle 12, as shown in FIGS. 3 and 4. Each of the plurality of first attachment portions 32 includes a projection 32A configured to be received by a corresponding opening in the door 14 of the vehicle 12.

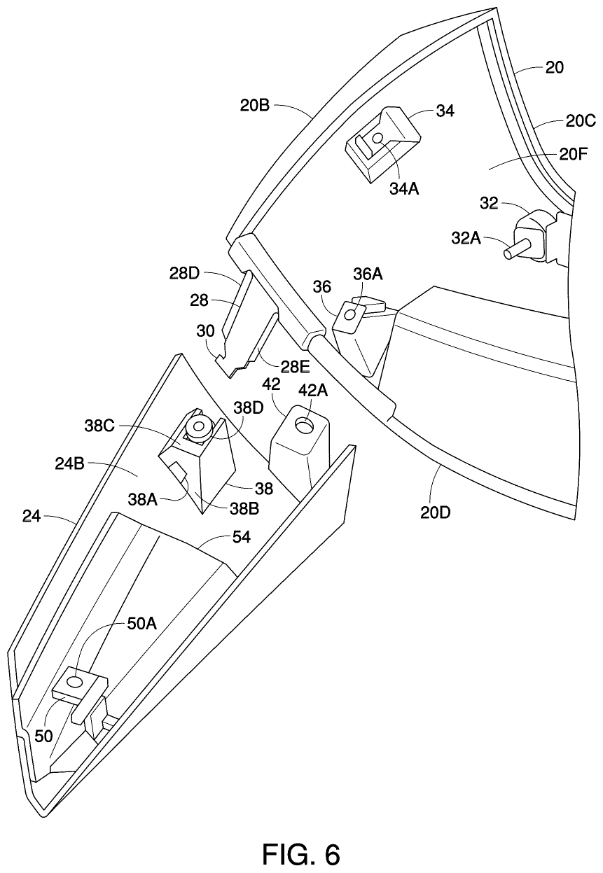

A plurality of second attachment portions 34 are disposed on the inner surface 20F of the main spoiler 20 to connect the main spoiler 20 to the door 14 of the vehicle 12, as shown in FIGS. 3 and 4. Each of the plurality of second attachment portions 34 has an opening 34A configured to receive a fastener 34B to facilitate securing the main spoiler 20 to the door 14, as shown in FIGS. 4 and 6. Preferably, the main spoiler 20 includes first and second second attachment portions 34 that are disposed proximate the first and second lateral edges 20A and 20B of the main spoiler 20. Each of the plurality of first attachment portions 32 is disposed between the first and second second attachment portions 34, as shown in FIG. 3.

A third attachment portion 36 is disposed on the inner surface 20F of the main spoiler 20 to facilitate connecting one of the side spoilers 22 and 24 to the main spoiler 20, as shown in FIGS. 3, 4 and 6. A first third attachment portion 36 is disposed proximate the first lateral edge 20A of the main spoiler 20, and a second third attachment portion 36 is disposed proximate the second lateral edge 20B of the main spoiler 20. An opening 36A is disposed in each of the third attachment portions 36 to facilitate receiving a fastener 36B, as shown in FIG. 4. The first third attachment portion 36 is configured to receive the first side spoiler 22, and the second third attachment portion 36 is configured to receive the second side spoiler 24, as shown in FIGS. 3 and 4.

The first side spoiler 22 has an outer surface 22A facing outwardly from the vehicle 12 when attached thereto, as shown in FIGS. 1 and 2. The first side spoiler 22 has an inner surface 22B facing toward the vehicle 12 when connected thereto, as shown in FIGS. 3, 4 and 6. The second side spoiler 24 has an outer surface 24A facing outwardly from the vehicle 12 when attached thereto, as shown in FIGS. 1 and 2. The second side spoiler 24 has an inner surface 24B facing toward the vehicle 12 when connected thereto, as shown in FIGS. 3, 4 and 6.

A first boss 38 of the second side spoiler 24 protrudes outwardly from the inner surface 24B of the second side spoiler 24, as shown in FIGS. 3-6. The first boss 38 is disposed on an inner surface 24A of the second side spoiler 24. An opening 38A extends through the boss 38. The opening 38A extends in a direction substantially parallel to the inner surface 24B of the second side spoiler 24. The opening 38A is configured to receive the second tab 28 when the second side spoiler 24 is connected to the main spoiler 20.

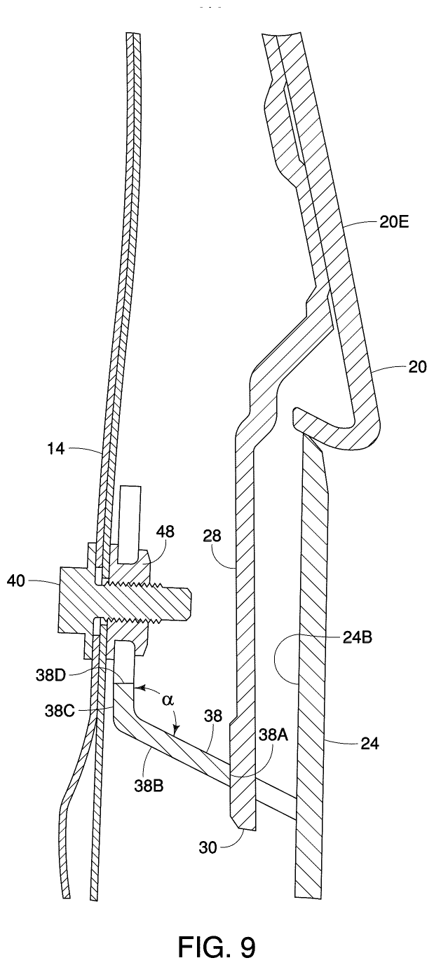

The first boss 38 includes a first wall 38B extending outwardly from the inner surface 24B and a second wall 38C extending outwardly from the first wall 38B, as shown in FIGS. 4, 6 and 9. An angle α is formed between the first wall 38B and the second wall 38C, as shown in FIG. 9. The angle α is preferably larger than 90 degrees. As shown in FIGS. 5, 6 and 9, the opening 38A extends through the first wall 38B of the first boss 38.

A first fastener opening 38D is disposed in the first boss 38, as shown in FIGS. 4, 6 and 9. The first fastener opening 38D is disposed in the second wall 38C of the first boss 38. The first fastener opening 38D is configured to receive a fastener 40 to secure the second side spoiler 24 to the vehicle 12. The first fastener opening 38D is configured to extend in a direction substantially perpendicular to the inner surface 24B of the second side spoiler 24.

A second boss 42 protrudes outwardly from the inner surface 34B of the second side spoiler 24, as shown in FIGS. 3, 4 and 6. The second boss 42 includes a second fastener opening 42A configured to receive the fastener 36B, as shown in FIG. 4, to secure the second side spoiler 24 to the main spoiler 20.

A third boss 50 protrudes outwardly from the inner surface 34B of the second side spoiler 24, as shown in FIGS. 4 and 6. The third boss 50 includes a fastener opening 50A configured to receive a fastener 52, such as a clip, to secure the second side spoiler 24 to the vehicle 12, such as to the door 14. The third boss 50 is substantially surrounded by a foam block 54 disposed between the inner surface 34B of the second side spoiler 24 and the door 14. The foam block 54 preferably surrounds three sides of the third boss 50.

The first side spoiler 22 is preferably a mirror image of the second side spoiler 24, such that a description thereof is omitted for brevity.

The first side spoiler 22 and the second side spoiler 24 are connected to the main spoiler 20 to form the spoiler assembly 18, as shown in FIGS. 3 and 4. The spoiler assembly 18 is then connected to the vehicle 12, as shown in FIG. 1.

As shown in FIG. 3, the second side spoiler 24 is connected to the main spoiler 20 proximate a second lateral edge 20B of the main spoiler 20. To connect the second side spoiler 24 to the main spoiler 20, the second side spoiler 24 is moved toward the main spoiler 20 such that the opening 38A in the first boss 38 receives the second tab 28. The hook 30 of the second tab 28 substantially prevents accidental withdrawal of the second tab 28 from the boss 38. The hook 30 of the second tab 28 facilitates connecting the second side spoiler 24 to the main spoiler 20 as the installer does not need to worry about holding the second side spoiler 24 to prevent separation of the second side spoiler 24 and the main spoiler 20 during installation. As shown in FIG. 5, a first width W1 of the second tab 28 is larger than a second width W2 of the opening 38A in the first wall 38B to substantially prevent withdrawal of the second tab 28 from the opening 38A in the boss 38. The tapered portion 28F of the second tab 28 limits an insertion depth of the second tab 28 in the opening 38A of the first boss 38. Receiving the second tab 28 with the first boss 38 of the second side spoiler 24 properly positions and aligns the second side spoiler 24 with respect to the main spoiler 20.

When the first boss 38 of the second side spoiler 24 receives the tab 28 of the main spoiler 20, the second boss 42 overlies the third attachment portion 36 such that the openings 36A and 42A are aligned, as shown in FIGS. 4 and 6. The fastener 36B is inserted through the opening 42A in the second boss 42 of the second side spoiler 24 and through the opening 36A in the third attachment portion 36 to secure the second side spoiler 24 to the main spoiler. The second tab 28 engages the wall defining the opening 38A in the first boss 38 when rotating the fastener 36B to substantially prevent movement of the second side spoiler 24 relative to the main spoiler 20. Preventing movement of the second side spoiler 24 relative to the main spoiler 20 maintains proper positioning and alignment between the second side spoiler 24 and the main spoiler 20.

The first side spoiler 22 is connected to the main spoiler 20 in a substantially similar manner as the second side spoiler 24. The first side spoiler 22 includes a first boss 44 configured to receive the first tab 26 of the first side spoiler 22. The first side spoiler 22 further includes a second boss 46 configured to overlie the third attachment portion 36 disposed proximate the first lateral edge 20A of the main spoiler 20.

Once the spoiler assembly 18 is assembled by securing the first and second side spoilers 22 and 24 to the main spoiler, the spoiler assembly 18 is connected to the rear door 14 of the vehicle 12. Each of the plurality of first attachment portions 32 on the inner surface 20F of the main spoiler 20 is configured to engage a corresponding opening in the door 14 of the vehicle 12.

Each of the plurality of second attachment portions 34 disposed on the inner surface 20F of the main spoiler 20 receives a fastener 34B to facilitate securing the main spoiler 20 to the door 14, as shown in FIGS. 4 and 6.

The fastener 40 is inserted through the rear door 14 and through the opening 38D in the first boss 38 of the second side spoiler 24, as shown in FIGS. 4 and 9. A nut 48 can be disposed on the fastener 40 to secure the fastener 40 to the door 14. As shown in FIG. 9, the inserted fastener 40 does not contact the second tab 28 of the second side spoiler 24 received by the first boss 38 of the second side spoiler 24. The first side spoiler 22 is similarly configured.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle spoiler assembly. Accordingly, these terms, as utilized to describe the present invention should be interpreted relative to a vehicle equipped with the vehicle spoiler assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle spoiler assembly, comprising:
a main spoiler configured to be secured to a vehicle;
a tab extending outwardly from the main spoiler;
a side spoiler configured to be connected to the main spoiler and to the vehicle;
a boss protruding outwardly from the side spoiler; and
an opening extending through the boss, the opening being configured to receive the tab when the side spoiler is connected to the main spoiler.

2. The vehicle spoiler assembly according to claim 1, wherein
a hook is disposed at a first end of the tab, the hook preventing accidental withdrawal of the tab from the boss.

3. The vehicle spoiler assembly according to claim 1, wherein
the boss is formed on an inner surface of the side spoiler.

4. The vehicle spoiler assembly according to claim 3, wherein
the boss includes a first wall extending outwardly from the inner surface of the first side spoiler and a second wall extending outwardly from the first wall, an angle being formed between the first wall and the second wall.

5. The vehicle spoiler assembly according to claim 4, wherein
the opening extends through the first wall of the boss.

6. The vehicle spoiler assembly according to claim 2, wherein
a first width of the first end of the tab is larger than a second width of the opening in the first wall of the boss.

7. The vehicle spoiler assembly according to claim 2, wherein
the tab includes a substantially planar surface, and first and second side walls extending substantially perpendicularly from the substantially planar surface.

8. The vehicle spoiler assembly according to claim 7, wherein
the first and second side walls of the tab extend from a second end of the tab toward the first end.

9. The vehicle spoiler assembly according to claim 8, wherein
a first length of each of the first and second side walls of the tab is less than a second length of the tab.

10. The vehicle spoiler assembly according to claim 1, wherein
the tab is integrally formed with the main spoiler as a one-piece member.

11. The vehicle spoiler assembly according to claim 1, wherein
a first fastener opening is disposed in the boss, the first fastener opening being configured to receive a first fastener to secure the side spoiler to the vehicle.

12. The vehicle spoiler assembly according to claim 11, wherein
the first fastener does not contact the tab when securing the side spoiler to the vehicle.

13. The vehicle spoiler assembly according to claim 11, wherein
a second fastener opening is disposed in the side spoiler and a third fastener opening is disposed in the main spoiler, the second fastener opening and the third fastener opening being configured to receive a second fastener to secure the side spoiler to the main spoiler.

14. A vehicle spoiler assembly, comprising:
a main spoiler configured to be secured to a vehicle;
a tab extending outwardly from an edge of the main spoiler;
a side spoiler configured to be connected to the main spoiler and to the vehicle;
a boss protruding outwardly from an inner surface of the side spoiler;
an opening extending through the boss; and
a hook disposed at a first end of the tab,
the tab being configured to be received by the opening when the side spoiler is connected to the main spoiler, and the hook being configured to engage the boss to prevent accidental removal of the side spoiler from the main spoiler when the side spoiler is connected to the main spoiler.

15. The vehicle spoiler assembly according to claim 14, wherein
the tab includes a substantially planar surface, and first and second side walls extending substantially perpendicularly from the substantially planar surface.

16. The vehicle spoiler assembly according to claim 15, wherein
the first and second side walls of the tab extend from a second end of the tab toward the first end.

17. The vehicle spoiler assembly according to claim 16, wherein
a first length of each of the first and second side walls of the tab is less than a second length of the tab.

18. The vehicle spoiler assembly according to claim 14, wherein
a first fastener opening is disposed in the boss, the first fastener opening being configured to receive a first fastener to secure the side spoiler to the vehicle.

19. The vehicle spoiler assembly according to claim 18, wherein
a second fastener opening is disposed in the side spoiler and a third fastener opening is disposed in the main spoiler, the second fastener opening and the third fastener opening being configured to receive a second fastener to secure the side spoiler to the main spoiler.

20. The vehicle spoiler assembly according to claim 14, wherein
the boss includes a first wall extending outwardly from the inner surface of the first side spoiler and a second wall extending outwardly from the first wall, an angle being formed between the first wall and the second wall, and
the opening extends through the first wall of the boss.
